(19) United States
(12) Patent Application Publication
(10) Pub. No.: US 2007/0219653 A1
(43) Pub. Date: Sep. 20, 2007

(54) Knowledge management system for requesting, gathering, and evaluating knowledge in a common environment

(75) Inventor: Ken Martin, Dallas, TX (US)

Correspondence Address: Fulbright & Jaworski L.L.P.;Fulbright Tower, Suite 5100, 1301 McKinney, Houston, TX, 77010-3095, US

(73) Assignee: Source Selection, Inc., Dallas, TX (US)

(21) Appl. No.: 11/384,870

(22) Filed: Mar. 20, 2006

(51) Int. Cl. G06F 17/00

(52) U.S. Cl. 700/90

(57) ABSTRACT

A computer implemented system and method for requesting, gathering, evaluating, and scoring knowledge. The system includes a first user interface for allowing a first group of users to define prompts and response choices, a second user interface for allowing a second group of users to view prompts and select response choices and view prompts without response choices and enter responses, and a third user interface for allowing a third group of users to evaluate previously-entered response by viewing the responses and selecting response choices. The system may automatically score the responses of the second group using scoring elements embedded in the response choices. The system may also include a relational database of related tables for storing the prompts, response choices, responses, evaluations, and user information. The system may also limit a user's access to various records based on the user's profile or a user responsibility associated with the user.

### CROSS-REFERENCE TO RELATED APPLICATIONS

Not applicable.

### TECHNICAL FIELD

The following relates generally to knowledge management systems, and more specifically to computer-implemented systems for gathering data from multiple organizations and analyzing and tracking the data gathered.

### BACKGROUND OF THE INVENTION

Many complex activities in business and civic life involve exchanges of massive amounts of data between multiple organizations. Each organization often stores and produces information in a different format than other organizations involved in the activity. Organizations may store and organize information using a disparate array of software and techniques including search engines, document management systems, desktop file systems, database, and paper copies to store documents such as spreadsheets, text files or graphic files. This information often passes through multiple organizations in electronic format as an e-mail attachment or stored on removable media or in hard copies that may be faxed or mailed. The receiving organization may then convert the information to another form and store it in a separate files system. As a result, massive amounts of manual labor are often required to convert information from one format to another. Such manual translation not only results in increased costs, but often results in critical errors when data is copied incorrectly or crucial pieces of data are omitted from a copy altogether. Thus, a desire exists for a knowledge management tool capable of gathering information from disparate sources for storage in a common format, eliminating the need for manual translation of information from one organization's format to another.

Additionally, the use of manual translation in the data gathering process often precludes the gathering organization from using the raw data in later phases of the project, or later auditing the data-gathering process. For example, information is often not readily available for analysis, collaboration, or distribution and requires a high-degree of inefficient manual intervention to maintain. Manual maintenance of data becomes especially cumbersome as the number of organizations and criteria involved increase and the subject matter becomes more complicated. The lack of transparency in the process and information, the complexity involved with managing disparate environments, and the lack of audit capabilities limit the amount of structure that can be applied to the measure and evaluation of complex multi-dimensional data sets. Thus, a desire also exists for a knowledge management tool capable of transparently storing and organizing gathered information for later analysis and auditing purposes.

The common procedure utilized by organizations with regard to requesting and evaluating bids through the use of a request for proposals (RFP) exemplifies common knowledge management practices currently in use. In an RFP, an organization lays out its requirements for a new project and request proposals responsive to those requirements from prospective vendors. The organization often wishes to evaluate those vendors both on objective criteria such as total cost and on subjective criteria such as the vendor's reputation for quality service. To obtain such information, the organization produces an RFP in the form of a questionnaire containing a large number of questions—some which call for quantitative responses, some which call for qualitative responses. The organization may distribute the questionnaire in various formats ranging from a website posting accessed by prospective vendors through an Internet browser, to a paper document faxed or mailed to prospective vendors to a file stored to an electronic file e-mailed or delivered on disk to the prospective vendors. The prospective vendors will then produce a response to the RFP in various formats ranging from a printed document faxed or mailed to the requesting organization to an electronic file stored in various proprietary formats e-mailed or stored on disc and mailed to the organization.

Upon receiving responses to the RFP, the organization must somehow evaluate the responses. As a preliminary step, the organization must enter the quantitative responses from all the vendors' responses into a common format for grading. This often involves an administrative staff member of the organization manually entering data into a spreadsheet. As discussed above, such manual entering of data often leads to mistakes such as incorrect entry of data or omission of data altogether. Such a mistake could lead the organization to ultimately select a non-ideal vendor. Additionally, any information accompanying those numbers, such as a paragraph qualifying the vendor's ability to provide a component, is lost when only the number is entered into the spreadsheet. For the subjective responses, an administrative staffer may make copies of the responses and distribute the copies around the organization for evaluation. The distribution of multiple copies creates a security risk that a copy may be lost and be viewed by unauthorized personnel. The administrator must then enter those evaluations into a common format to store the grades. The evaluators may fill out a form with grades that an administrative staffer must transcribe into a spreadsheet for grading. Such tasks often quickly becomes overwhelming. For example, analysis involving 3,000 criteria may have 15,000 questions sent to 10 organizations with a request for response. The total number of response to be evaluated is 15,000×10=150,000. Additionally, as discussed above, any information contained in the responses not transferred by the evaluators into the scoring application may be lost.

### BRIEF SUMMARY OF THE INVENTION

The present invention is directed to a computer-based system and method for requesting, gathering, evaluating, and scoring knowledge in which an application server presents a plurality of user interfaces to a first, second, and third groups of users. In some embodiments the application server may present some or all of the user interfaces through software for displaying the user interfaces on a plurality of remote computers connected by a network connection to the application server. In one embodiment, the first user interface allows a first group of users to create a number of response segments. The first user interface in some embodiments also allows a first group of users to designate which response segments will later require evaluation, as well as to define a set of data values to be presented as choices and displayed with some response segments where each data value is assigned a score. In one embodiment, a second user interfaces allows a second group of users to view some response segments along with a set of data values and select a choice among those values and to view other response segments without any set of data values and simply enter a response to the response segment. A third user interface in one embodiment allows a third group of users to view responses entered by the second group of users and evaluate those responses by selecting a choice from a set of data values. In some embodiments, the application server automatically scores the responses and selections entered by the second group of users using the scores associated with the data values selected by the second group of users in response to displayed response segments and the scores associated with the data values selected by the third group of users in evaluating the displayed responses.

In some embodiments, the second user interface may only display certain response segments to a specific user in the second group of users. The user interface may only display those response segments associated with that particular user's profile. Similarly, the third user interface in some embodiments may only display responses associated with a particular user's within the third group of users profile. In some embodiments, the first and third groups of users discussed above may belong to the same organization while the second group of users may belong to several geographically diverse organizations.

In some embodiments, the system stores and displays data stored in a relational database containing several related tables where each table contains a number of entries. The system may contain a table of response segments, a table of responses where each response is associated with at least one response segment, a table of evaluation segments where each evaluation segment is associated with at least one response segment, and a table of evaluations where each evaluation is associated with at least one evaluation segment. The relational database in some embodiments also contains a table of user responsibilities where each user responsibility is associated with at least one response segment or at least one evaluation segment, and a table of users where each user is associated with at least one user responsibility. The application server in some embodiments may limit a user's access to only those response segments and evaluation segments with which that user's user responsibility is associated.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is an illustration of several tables and associations between those tables of the relational database structure of one embodiment.

FIG. 2 is an illustration of a multi-tier server architecture for implementing one embodiment.

FIG. 3 is an illustration of a user interface in one embodiment that allows an administrator to select various elements of the Solutions Template to include in his or her program.

FIG. 4A is an illustration of a user interface in one embodiment that allows an administrator to define a program, projects within a program, and phases within a project.

FIG. 4B is an illustration of a user interface in one embodiment that allows an administrator to define the responsibilities of users within a specific project.

FIG. 4C is an illustration of a user interface in one embodiment that allows an administration to create and define user responsibilities.

FIG. 4D is an illustration of a user interface in one embodiment that allows an administrator to add or remove reference categories from the reference categories to which users with a specific responsibility have access.

FIG. 5A illustrates a user interface in one embodiment that allows an administrator to create criteria, enter information about a criterion, associate the criterion with a reference category, and assign response blocks to the criterion.

FIG. 5B illustrates a user interface containing various data control elements that allows an administrator to define text and associated numeric values for ratings in one embodiment.

FIG. 5C illustrates a user interface in one embodiment that allows an administrator to create a response block and define multiple response segments related to the response block.

FIG. 5D illustrates a user interface in one embodiment that allows administrator to create a Value Set.

FIG. 6 illustrates a user interface in one embodiment that allows a user to read criterion prompt and enter responses to the response segments of the response block associated with the criterion.

### DETAILED DESCRIPTION OF THE INVENTION

Database Structure

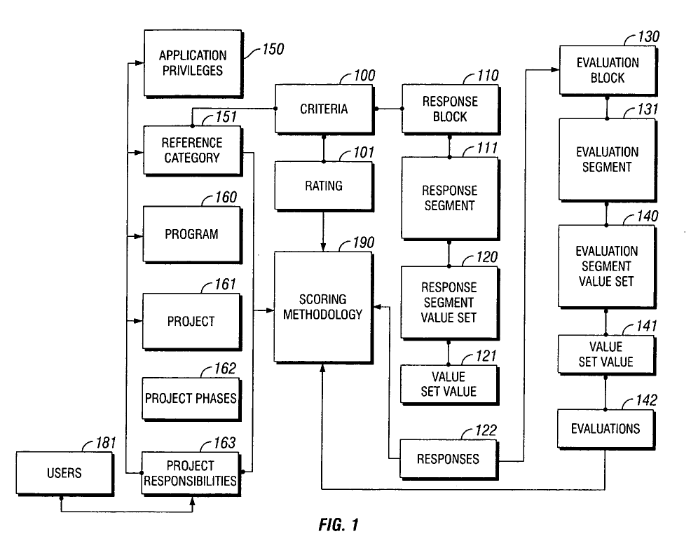

Turning to FIG. 1, examples of relational database tables and associations in one embodiment of the invention are shown. As is well-known in the art, each table (represented by a box in FIG. 1) contains a number of columns and a number of rows, where each column represents a field of information and each row represents a separate entry. Exemplary fields for some tables in one embodiment are listed in Table 1. Some embodiments may contain more tables or tables with different columns than the exemplary embodiment of FIG. 1 and Table 1. In some embodiments, each table has a column that serves as the primary key for the table such that each row contains a unique or primary ID in that column. FIG. 1 also illustrates the relationships between various tables in one embodiment through lines connecting the tables. As is known in the art, these relationships may be established by placing a foreign ID column, i.e. a column containing primary ID's of another column, in a table. These relational columns are not listed in Table 1. For example, the Response Segment table 111 may contain a column for Response Block IDs. Thus, a row in the Response Segment table 111 with an entry “5” in the Response Block ID column would be associated with the row of the Response Block table 110 with the primary ID “5.” Specific uses of the exemplary relational database tables of FIG. 1 are discussed below throughout the discussion of the functionality of one embodiment of the system.

TABLE 1

Criteria
ID
Name
Type
Status
Rating
Rating ID
Sequence
Name
Numeric Value
Response Block
ID
Name
Description
Response Segment
ID
Name
Description
Prompt
Dependent Response Segment:
Dependent Value Set ID,
Dependent Value ID, Dependent
Value
Response Segment Value Set
ID
Name
Value Set Value
ID
Name
Score
Responses
Responder's User ID
Response Segment ID
Response Segment Value
Response Segment Score
Evaluation Block
ID
Name
Description
Evaluation Segment
ID
Name
Description
Prompt
Dependent Evaluation Segment:
Dependent Value Set ID,
Dependent Value ID, Dependent
Value
Evaluation Segment Value Set
ID
Name
Value Set Value
ID
Name
Score
Evaluations
Responder User ID
Evaluator User ID
Evaluation Segment ID
Evaluation Segment Value
Evaluation Segment Score
Application Privileges
Feature ID
Feature Name
Function ID
Function Name
Report ID
Report Name
Reference Category
ID
Name
Description
Program
ID
Name
Description
Type
Status
Project
ID
Name
Description
Type
Project Phases
ID
Name
Description
Project Responsibilities
ID
Name
Description
Start Date
End Date
% Score
Subscription Administration
Organization ID
Contact Information
Subscription ID
Collaboration ID
Administrator ID
Organization Role
ID
Responsibility ID
Responsibility Name
Distribution Broker
Subscription ID
Organization ID
Collaboration ID
Solution ID
Users
ID
Contact Information
Organization ID
Collaboration ID

System Architecture

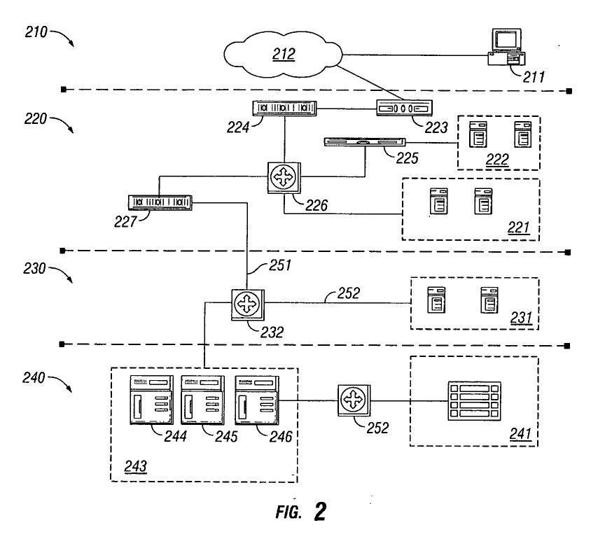

Turning to FIG. 2, in one embodiment a multi-tiered architecture used to store the relational database tables of FIG. 1 and to allow users to enter and view data by delivering various user interfaces to users over the Internet 212 via computer with a web browser interface 211. In one embodiment, the multi-tiered architecture consists of an end-user tier 210, a web tier/security zone 220, an application server tier 230, and a database tier 240. While such a multi-tier system provides security and load balancing advantages, such an architecture is used only in some embodiments of the invention. Similarly, while specific components may appear separately in the exemplary embodiment of FIG. 2, these functional components may be performed by more limited, more expansive, or different hardware in other embodiments. In one embodiment, the end-user tier 210 contains a client computer with a web browser interface 211 that connects to the web tier/security zone through the Internet 212. In some embodiments, the client computers 211 may connect to the web tier/security zone 220 via a company intranet instead of via the Internet 212. In one embodiment, the web browser interface 211 is a Java™-enabled.

The web tier/security zone 220 in one embodiment contains a router 223 and firewall 224 that connect the system to the Internet. The web tier/security zone in one embodiment contains web servers 222 for delivering user interfaces to client computers and network area storage, file & print servers 221 that may store copies (caches) of commonly-used reports and other data so that when a user request such data, the system need not contact the application server tier 230 or the database tier 240. The file servers may store attachments uploaded by users and the print servers may allow a user in one location to send a document to a printer in another location. In one embodiment, a switch connects the network area storage file & print servers, the web servers 222 through a load balancer 225, and the application server tier 230 through a firewall or VPN 227 to the end-user tier through a firewall 224 and a router 223. The connections 251 between hardware elements may be made in one embodiment using 100 Base T or other data cables well known in the art to enable high-speed data transfer. In one embodiment, the firewall 224 and firewall or VPN 227 protect the system from access by unauthorized users.

In one embodiment, the application server tier 230 contains application & report servers 231 for storing programs that communicate with the database servers. The software on the client's computer may interact with the programs on the application servers to request information and generation of reports. A switch 232 may connect the database tier 240 and application & report servers 231 to the web tier/security zone 220. These connections 252 may be made using GigE fiber channels or other data cables known in the art to enable high-speed data transfer. In one embodiment, the database tier contains database servers 243 connected to the application server tier 230 that may be connected to a storage area network 241 by a switch 252. In one embodiment, the storage area network is a stack of hard drives for storing data for the database servers 243. In one embodiment, the database servers 243 may include a data integration server 244 for accessing external data sources and prestaging that data, an OLTP (On-Line Transaction Processing) server 245 containing the actual database, and a reporting server 246 for load balancing. A data integration sever thus provides Publish and Subscribe services, as are known in the art. The connections 252 within the database tier may be made using GigE fiber channels or other data cables known in the art to enable high-speed data transfer.

System Operation

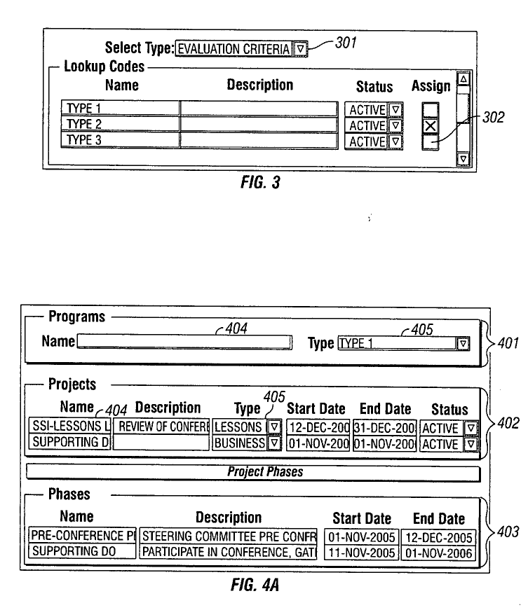

In one embodiment, the system presents each user with a control panel that allows the user to access all user interfaces to which that user is allowed access. From this panel, the user may access the user interfaces discussed herein. To create a new program in one embodiment, an administrator may start with a Solutions Template. A Solution Template may contain a set of pre-defined program 160 and project 161 structures containing pre-defined responsibilities 163, pre-defined criteria 100, pre-defined response blocks 110, pre-defined evaluation blocks 120, pre-defined scoring methodologies 190, and pre-defined reports. FIG. 3 illustrates a user interface in one embodiment that allows the administrator to select various elements of the Solutions Template to include in his or her program. Using this interface, an administrator may select a table such as Criteria 100 or Reference Categories 151 from the pull-down menu 301 and the interface will list all the pre-defined columns for the selected table. The user may then add those columns to the table in its program by selecting the checkbox 302 corresponding to a particular pre-defined column. In some embodiments, the Solutions Template may evolve to include more elements as various administrators create custom elements for specific projects and add those elements to the Solutions Template. In some embodiments, the administrator may not use a Solutions Template and may simply begin adding columns to the tables using the interfaces described below.

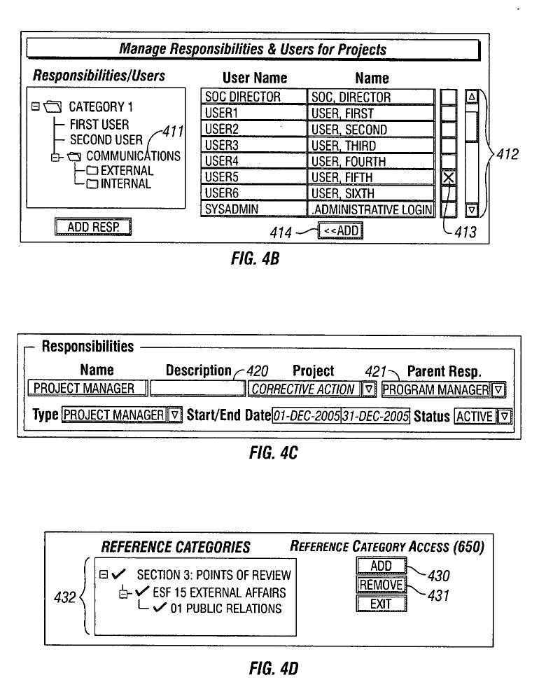

In one embodiment, an administrator uses the user interface illustrated in FIG. 4A to define a program 160, projects 161 within a program, and phases 162 within a project. The interface may contain a section 401 with various data entry devices such as text boxes 404 and drop down menus 405 that allow the administrator to define the programs 160. Each new program is a new row in the Program table 160 where each of the data entry devices supplies information for a column. The system further defines a unique Program ID for the program. Similarly, the interface may contain section 402 with various data entry devices 404, 405 that allow the administrator to define projects 161 of the program. Each new project is a new row in the Project table 161 where each of the data entry devices supplies information for a column. The system further defines a unique Project ID for each new project and also enters the Program ID of the associated program in the Program ID column of the Project table 161. In some embodiments, a user may create a project independent of a program and later define the association between a project and a program. An administrator creates phases 163 using a similar interface and process. In some embodiments, the interface for creating phases may presented to the user as part of the same interface of FIG. 4A. In some embodiments, the user may bring up the window for adding phases by right-clicking a mouse on a project and selecting the “phases” option from the menu that appears when the user right clicks on the project name.

In one embodiment, the administrator controls user access to application features and functions 150 and reference categories 151 by defining responsibilities 163 such that users 181 assigned a particular responsibility may only access those application features and functions 150 and reference categories 151 associated with that responsibility 163. The use of responsibilities allows the system to provide a collaborative environment across multiple organizations while providing security to limit user access only to authorized features and applications. FIG. 4B illustrates a user interface in one embodiment that allows an administrator to define the responsibilities of users within a specific project. In one embodiment, the interface illustrated in FIG. 4B may be presented to the user as part of the same interface of FIG. 4A. In some embodiments, the user may bring up the window for adding responsibilities by right-clicking a mouse on a project and selecting the “user responsibilities” option from the menu that appears when the user right clicks on the project name. Turning to the exemplary embodiment in FIG. 4B, the user is presented a list of responsibilities 163 on the right side of the screen in a nested list 410 in which the users already assigned to a responsibility are nested within that responsibility. On the left side of the screen, the user is presented a list of every user 412 with a checkbox 413 next to each user. To add users to a responsibility, the user selects a responsibility by clicking on a responsibility on the right side of the screen, selects the checkbox next to all users to be placed in a responsibility, and then selects the “Add” button 414. When the user selects the “Add” button 414, the system enters the Responsibility ID of the selected responsibility in the Responsibility ID column of the selected users' rows in the Users table 181.

In some embodiments, a user defines a number of reference categories 151, and may link each criteria to a reference category (one embodiment of a user interface for linking a criteria to reference category is discussed below). The Reference Category table 151 may have a recursive column that allows a reference category to link back to a parent reference category, thus creating a parent-child structure. Using this parent-child structure, an administrator may grant users of a certain responsibility access to criteria linked to several reference categories simply by granting users with that responsibility access to the parent reference category. In some embodiments, reference categories may be further grouped into Reference Category Types where a single reference category may be a member of several Reference Category Types. A user may also improve the relevance of search results by searching only specific reference categories.

In some embodiments, the system may also provide the user with a user interface that allows the user to create and define responsibilities. In some embodiments, user responsibilities may be presented to the users as “roles.” A user interface in one embodiment that allows an administrator to add and define responsibilities is illustrated in FIG. 4C. The user interface may contain data control elements such as text fields 420 and drop down menus 421 for defining columns of information of the responsibility. In some embodiments, the user may use a drop down box 421 to define parent responsibilities. By allowing administrators to define parent responsibilities, the system allows administrators to assign some users multiple areas of responsibility by assigning the user a parent responsibility with several children. In some embodiments, the user may right-click a mouse on the responsibility name to bring up a menu that provides access to more user interfaces for further defining user responsibilities. The menu may provide access to a user interface such as the interface illustrated in FIG. 4D. In the user interface illustrated in FIG. 4D, the administrator may add or remove reference categories 151 from the reference categories to which users with a specific responsibility have access using the “Add” 430 and “Remove” 431 buttons. The selected reference categories appear in the nested list 432. In some embodiments, the administrator may also add and remove application privileges 150 to which users with a specific responsibility have access using the “Add” 430 and “Remove” 431 buttons. Application privileges 150 include application features and functions. Thus, in a responsibility-based configuration of the program, the application only grants the user access to features and functions associated with that user's responsibility. The application further only provides the user access to reference categories associated with that user's responsibility. In some embodiments, an administrator may assign a user more than one responsibility in which case the application may allow the user to select a single responsibility for a specific session.

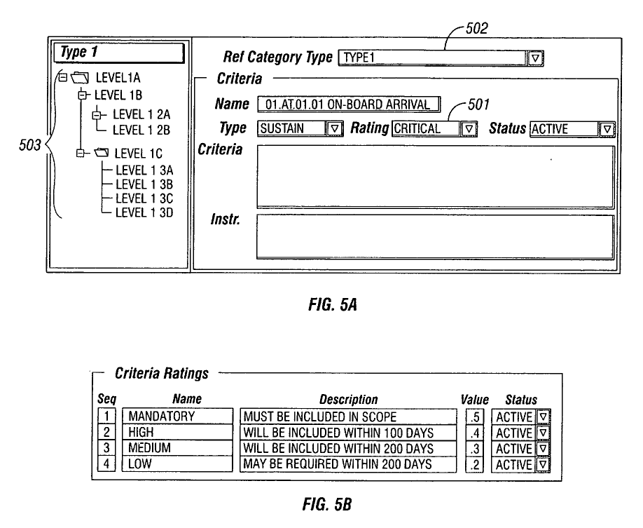

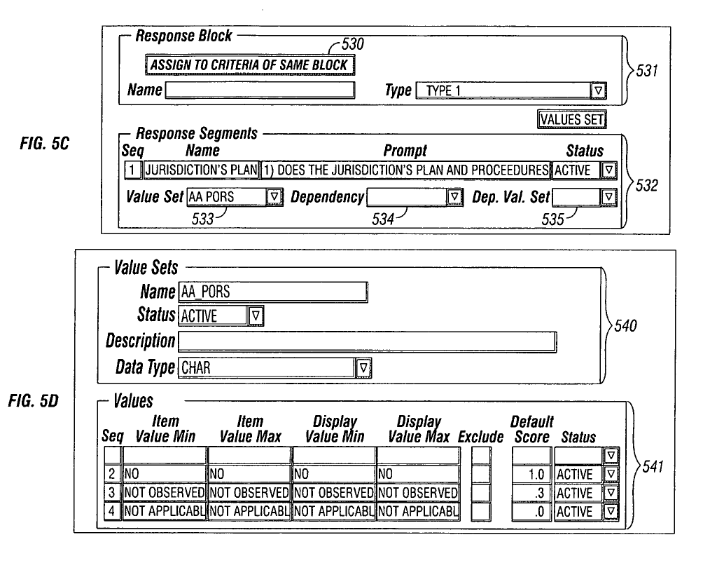

FIG. 5A illustrates a user interface in one embodiment that allows an administrator to create criteria 100, enter information about a criterion, associate the criterion with a reference category 151, and assign response blocks 200 to the criterion. In some embodiments, when a user creates a new criterion, the system assigns the criterion a system generated Criterion ID. The user may also associate a Rating 101 with the criterion. In the embodiment illustrated in FIG. 5A, a drop-down menu 501 lists the text of available ratings and allows the user to select a rating. When a user selects a rating, the system places the Rating ID of that rating in the Rating ID column of that criteria's row in the Criteria 100 table. FIG. 5B illustrates a user interface containing various data control elements that allows the administrator to define text and associate numeric values with a set of ratings in one embodiment. In some embodiments, the rating 101 associated with a criterion 100 may factor into the scoring methodology 190. In one embodiment, the value assigned to the rating will be applied to the score of responders or evaluators for criteria assigned that rating. Thus, an administrator may assign additional weight in a later scoring to responses to criteria with one rating over criteria with another rating.

In some embodiments, the user may associate a criterion with a reference category 151. When the user places the criterion in a reference category, the system enters the Reference Category ID of the selected reference category in the Reference Category ID column of the criterion's row in the Criteria table 100. In one embodiment, the user may place a criterion in a reference category by selecting the Reference Category Type from a pull-down menu 502, selecting the appropriate reference category from the nested list 503 and selecting the “Add” button 504. In some embodiments, this selection process is similar to the process of adding a user to a specific responsibility as illustrated in FIG. 5B. Such a common interface allows the user to quickly learn to use the system.

FIG. 5C illustrates a user interface in one embodiment for creating a response block and defining multiple response segments related to the response block. In some embodiments, the user may associate a response block 110 with a criterion 100. A user may directly select a response block for a criterion in some embodiments. In some embodiments, the user may use button 530 as illustrated in FIG. 5C to assign the current response block to all criteria of the same type (note both response blocks and criteria have a “Type” column). In some embodiments, when the user creates a Response Block the system assigns a Response Block ID. The user may define the response block by entering data in a number of data control elements such as text boxes and drop-down menus. In some embodiments, the user may then define one or many Response Segments 111 associated with the Response Block. When the user creates a new response segment, the system enters the Response Block ID of the current response block in the Response Block ID column of the response segment's row in the Response Segment table. The system may also assign a Response Segment ID to the new response segment. In some embodiments, the user may also choose a Value Set 120 from a drop down menu 533 for each Response Segment 111. When the user selects a value set for a response segment, the system assignss the Value Set ID of that value set in the Value Set ID column of the response segment's row in the Response Segment table 111. In some embodiments, the user may use drop down menus 534, 535 to define a data dependency for a response segment such that when a responding user enters of a specific value 121 in the response segment 111, the system presents the responding user with an additional response segment or segments not presented to users not entering the specified value. The administrator may define these dependency rules by specifying the dependent response segment name and the value set value that triggers the system to present the user with that dependent response segment or segments. In some embodiments, the system stores the dependency rule as part of an on-entry data validation process that the system performs each time a responding user enters data. In some embodiments, the user may further specify whether a Response Segment 111 will require evaluation. A user may wish to require evaluation of a specific response segment where the response segments prompts the user for qualitative data not easily included in a scoring system without further quantitative evaluation. The process of creating evaluation blocks 130 is discussed in detail, below.

FIG. 5D illustrates a user interface in one embodiment for creating a value set 120, 140. In some embodiments, value sets may be used both in response segments and evaluation segments. The system may assign each newly created value set 120, 140 a Value Set ID. In the embodiment shown in FIG. 5D, an administrator may use the same user interface to create Response Segment Value Sets 120 and Evaluation Segment Value Sets 140. Value sets provide responding users with a set of responses from which to select when responding to a response segment associated with that value set. In one embodiment, the user may configure the value set 120 to contain data entry controls that allow the user to enter responses in multiple forms including binary, text, dates, data ranges, a list of values, or even attach documents. The user may define the value set using the data entry elements 540. A value set 120 may contain data entry controls that allow the user to provide any type of response. In some embodiments, certain data controls will have values 121 associated with each value set. The user may create new values using the data entry controls 541. When a user creates a new value, the system may assign each value 121 a Value ID. In some embodiments, the user may assign each value 121 a text label as well as a numerical score. This numerical score may figure into a scoring criteria. For example, a value set may contain four values, each of which are given a different numerical score reflecting the desirability of the value. Since the administrator assigns numerical scores to values before responding users even enter any data, the responding users' responses may be used in scoring calculation without any other manual action by an administrator.

While the system may automatically score user responses to Value Sets 120 with lists of values 121 containing associated scoring numbers, the system in some embodiments may also provide a separate user interface that allows a separate group of users—evaluators—to evaluate other types of responses. To accomplish this, in some embodiments the user may choose to create and associate an evaluation block with a response segment that contains qualitative information. In response to a user indicating that a particular response block will require evaluation, the system enters the Response Segment ID of that response segment in the Response Segment ID column of the new evaluation block's row in the Evaluation Block table 130. The system may assign new evaluation blocks 130 a Evaluation Block ID. Each evaluation block 130 may contain any number of evaluation segments 131. In some embodiments, the administrator defines an evaluation block using a user interface similar to the interface illustrated in FIG. 5C using the data control elements 531. In some embodiments, when the user creates an evaluation segment using the data control elements 532, the system assigns an Evaluation Segment ID to the new evaluation segment. The system may also assign the Evaluation Block ID of the current evaluation block in the Evaluation Block ID column of the evaluation segment's row in the Evaluation Segments table 131. Just as with response segments 111, the user may assign a value set 140 to each evaluation segment. In some embodiments, these value sets 140 may contain a number of values 141 with system-generated IDs, and user-entered text labels and numerical values. An administrator may create and edit value sets 140 using the user interface illustrated in FIG. 5D. In some embodiments, an administrator would likely not create a value set 140 without a set of values 141 since the purpose of evaluators is to assign a numerical value to a qualitative response inputted by a responding user.

As discussed above, several tables may include scoring elements, including value set values (for use with both response segments and evaluation segments), ratings, project responsibilities, and reference categories. In some embodiments, the user may use a Formula Builder to create formulas that combine various score elements For example, a user may define a formula to make all scored elements within a of a certain reference category type equal 25% of a total score. In another example, a user may choose to weigh the evaluation scores entered by users belonging to various responsibilities differently. A user could also use the ratings assigned to criteria in some category and weigh responses to criteria differently for criteria with different ratings. In some embodiments, the Formula Builder may use the Scoring Methodology table 190 to store relationships to scoring elements. Such formulas may be stored as scenarios that provide decision makers with multiple views and an audit trail of the scoring elements.

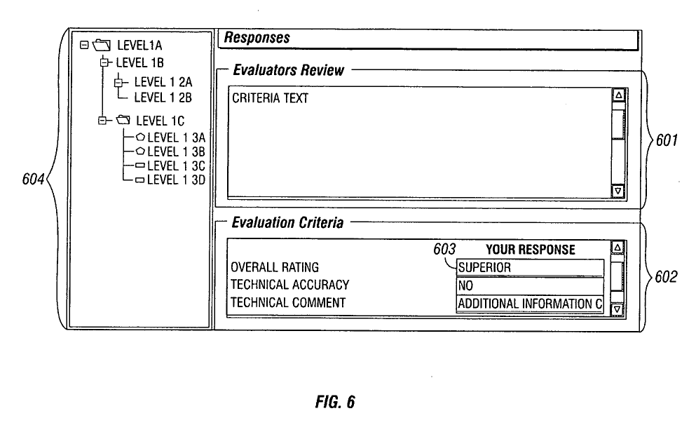

After a user has defined criteria, in some embodiments, the system allows respondents from disparate organizations to respond to the criteria through the web-based user interface. FIG. 6 illustrates a user interface in one embodiment that allows a user to read criterion prompt 601 and enter responses to the response segments 603 of the response block 602 associated with the criterion 100. In one embodiment, the user interface also contains a nested list 604 of reference categories and the criteria within each category. The nested list may contain icons or other visual cues next to each criterion that indicates to the responding user whether the responding user has responded to all response segments in that criterion. The nested list may further allow the responding user to navigate within the criteria.

The system may allow the responding user to view and access response segments in reference categories associated with that responding user's responsibility. The responding user may be required to respond to any number of data control elements including text boxes, checkboxes, drop down menus, or prompts to attach a file. In some embodiments, when a user enters a response to a response segment, the system stores that response as a row in the Responses table 122. The system may create a new Response ID for the response and enter the Response Segment ID and User ID into the appropriate columns of the response's row in the Response table. The system may also enter the Value ID into the appropriate columns of the response's row in the Response table if the user selected a value. Additionally, as discussed above, the system may perform an on-entry data validation process when the responding user enters data where that process may cause the system to present additional or different response segments to the responding users based on the responding user's previous response.

As discussed above, in some embodiments a separate group of users from the responding users may read qualitative responses entered by responding users and answer a series of quantitative questions to evaluate the response. In some embodiments, the system provides access to responses only in reference categories associated with the evaluating user's responsibility. The system may further limit the evaluating user's access to specific users. In some embodiments, the system pulls specific responses from the database and presents them in read-only format to the evaluating user. The evaluating user may evaluate responding users' responses using a user interface similar to the user interface illustrated in FIG. 6. The evaluating user may view a response in the text box 601 and then evaluate the response by responding to evaluation segments 603 within the evaluation block 602. In some embodiments, user interface may contain a nested list of reference categories 604 that the evaluating user may use for navigation or as a visual guide as to what responses remain to be evaluated.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for presenting a plurality of user interfaces to a plurality of remote computers having a computer-readable medium encoded with software for presenting said plurality of user interfaces, said system comprising an application server including a computer readable medium, wherein the computer-readable medium is encoded with:
one or more code segments to present a first user interface for allowing a first group of users to create response segments, for allowing said first group of users to designate a response segment as requiring evaluation, for allowing said first group of users to define a plurality of data values to be presented as choices, and for allowing said first group of users to associate scores with said plurality of data values;
one or more code segments to present a second user interface for displaying at least one of said response segments and at least one of said plurality of data values and allowing said second group of users to select at least one of said plurality of data values in response to said response segments and for displaying at least one of said response segments without one or more of said plurality of data values and allowing said second group of users to enter a response;
one or more code segments to present a third user interface for allowing a third group of users to view said data entered through said second interface by said second group of users and evaluate said data by selecting one or more of said plurality of data values in response wherein said third group of users are only presented said data entered by said second group of users in response to response segments designated by said first group of users as requiring evaluation; and
one or more code segments to automatically grade said second group of users' and said third group of users' selections of one or more of said plurality of data values using said scores associated with said plurality of data values by said first group of users.

2. The system of claim 1 wherein said one or more codes segments to present a second user interface display to a user within said second group of users is further encoded to display to a specific user within said second group of user only those response segments associated with that user's profile.

3. The system of claim 1 wherein said one or more codes segments to present a third user interface display to a user within said third group of users is further encoded to display to a specific user within said third group of user only those elements of data entered through said second interface by said second group of users associated with response segments associated with that user's profile.

4. The system of claim 1 wherein said first group of users and said third group of users belong to the same organization and said second group of users belong to a plurality of geographically diverse organizations.

5. The system of claim 1 further comprising a database server including a computer readable medium, wherein the computer-readable medium is encoded with a relational database structure comprising:
a table comprising a plurality of response segments;
a table comprising a plurality of responses wherein each of said plurality of responses is associated with at least one of said response segments;
a table comprising a plurality of evaluation segments wherein each of said plurality of evaluation segments is associated with at least one of said response segments;
a table comprising a plurality of evaluations wherein each of said plurality of evaluations is associated with at least one of said evaluation segments;
a table comprising a plurality of user responsibilities wherein each of said plurality of user responsibilities is associated with at least one of said response segments or at least one of said evaluation segments;
a table comprising a plurality of users wherein each of said plurality of users is associated with at least one of said plurality of user responsibilities; and
wherein said one or more code segments to present a second user interface for displaying said response segments and allowing said second group of users to enter data in response to said response segments is further encoded to only present a user associated with a user responsibility with response segments associated with that user responsibility.

6. The system of claim 5 wherein said database server and said applications server are physically located on the same server.

7. A database server including a computer readable medium, wherein the computer-readable medium is encoded with a relational database structure comprising:
a table comprising a plurality of response segments;
a table comprising a plurality of responses wherein each of said plurality of responses is associated with at least one of said response segments;
a table comprising a plurality of evaluation segments wherein each of said plurality of evaluation segments is associated with at least one of said response segments;
a table comprising a plurality of evaluations wherein each of said plurality of evaluations is associated with at least one of said evaluation segments;

8. The database server of claim 5 wherein said relational database structure further comprises:
a table comprising a plurality of user responsibilities wherein each of said plurality of user responsibilities is associated with at least one of said response segments or at least one of said evaluation segments;
a table comprising a plurality of users wherein each of said plurality of users is associated with at least one of said plurality of user responsibilities; and
wherein said computer readable medium is further encoded with one or more code segments to present a user interface for displaying at least one of said plurality response segments to a user wherein said one or more code segments are encoded to only display to a specific user those response segments associated with a user responsibility that is associated with that user.

9. The database server of claim 5 wherein said relational database structure further comprises:
a table comprising a plurality of reference categories wherein each of said plurality of reference categories is associated with a plurality of response segments;
wherein a user responsibility may be associated with a reference category such that all response segments associated with that reference category are associated with that user responsibility.

10. A computer-implemented method for a first organization to request, collect, evaluate, and score data from a plurality of disparate organization wherein each of said plurality of disparate organizations possesses at least one remote computer for communicating over a network with an application server, said method comprising the steps of:
at least one member of said first organization using said application server to define a plurality of response blocks;
at least one member of said first organization using said application server to define a plurality of response segments and associate said plurality of response segments with said plurality of response blocks wherein at least one of said plurality of response segments is defined such that when presented to a disparate organization by the application server, the application server will present the response segment and a set of choices, and at least one of said plurality of response segments is defined such that when presented to a disparate organization by the application server, the application server will present the response segment without a set of choices;
at least one member of said first organization using said application server to associate scores with said set of choices;
at least one member of said first organization using said application server to designate at least one of said response segments as requiring evaluation;
at least one member of said first organization configuring said application server to present each of said plurality of disparate organizations with at least one of said response blocks associated with said response segments, allowing said disparate organizations to enter responses by selecting a value from at least one of said sets of choices, and to present each of said plurality of disparate organizations with at least one of said response blocks associated with said response segments, allowing said disparate organizations to enter responses without selecting a value from at least one of said sets of choices; and
at least one member of said first organization using said application server to view at least one of said responses to a response segment entered by said plurality of disparate organizations designated as requiring evaluation and to evaluate said responses by selecting a value from at least one of said sets of choices.

11. The computer-implemented method of claim 10 further comprising the step of:
at least one member of said first organization using said application server to score said responses entered by said plurality of disparate organizations using the scores associated with said selections of values by said plurality of disparate organizations and said selections of values by said at least one member of said first organization entering evaluations.

12. A computer-implemented method for a first organization to request, collect, evaluate, and score data from a plurality of disparate organization wherein each of said plurality of disparate organizations possesses at least one remote computer for communicating over a network with an application server, said method comprising the steps of:
storing a plurality of response blocks entered by at least one member of said first organization as entries in a table of response blocks in a relational database;
storing a plurality of response segments entered by at least one member of said first organization where at least one of said response segments is defined to be displayed with a set of choices and at least one of said response segments is defined to be displayed without a set of choices;
storing a plurality of choices entered by at least one member of said first organization where each choice has an associated score;
designating, at the command of at least one member of said first organization, at least one of said response segments as requiring evaluation;
displaying to at least one member of each of said plurality of disparate organizations at least one response segment with a set of choices and storing said member's selection and displaying to at least one member of each of said plurality of disparate organizations at least one response segment without a set of choice and storing said member's response; and
displaying to at least one member of said first organization at least one of said responses entered in response to a response segment designated at requiring evaluation and a set of choices and storing said member's selection.

13. The computer-implemented method of claim 12 further comprising the step of:
calculating a score for each of the plurality of disparate organizations using the selections entered by said disparate organizations and the selections entered by said at least one member of said first organization evaluating said responses.

14. A computer-implemented method for efficiently scoring a plurality of responses from a first group of users to a plurality of prompts comprising the steps of:
defining a plurality of user prompts;
defining a plurality of value sets each containing a plurality of values with a display value and a scoring value;
displaying at least one of said plurality of prompts with at least one of said plurality of value sets to a first group of users and recording said first group of users' selections of values;
displaying at least one of said plurality of prompts without value set to a first group of users and recording said plurality of users' responses;
displaying said plurality of user responses with at least one of said plurality of value sets to a second group of users and recording said second group of users' selections of values; and
mathematically combining the scoring values associated with said first group of users' selections of values and said second group of users' selections of values to score said first group of users' responses to said plurality of prompts.

15. The computer implemented method of claim 14 wherein the step of displaying said plurality of user responses with at least one of said plurality of value sets to a second group of users further comprise the steps of:
displaying to a specific user within said second group of users only those user responses within said plurality of user responses entered in response to a specific prompt where that prompt is associated with the profile of said specific user within said second group of users.
